(19) United States
(12) Patent Application Publication
(10) Pub. No.: US 2012/0176316 A1
(43) Pub. Date: Jul. 12, 2012

(54) Wireless Mouse Supplier and Wireless Mouse Supply System

(75) Inventor: Lei JIN, Beijing (CN)

(73) Assignee: BEIJING SIGMACHIP CO.,LTD., Beijing (CN)

(21) Appl. No.: 13/072,792

(22) Filed: Mar. 28, 2011

(30) Foreign Application Priority Data
Jan. 7, 2011 (CN) 201120008130.1

(51) Int. Cl. G06F 3/033

(52) U.S. Cl. 345/163

(57) ABSTRACT

A wireless mouse supplier, disposed within a notebook computer, supplies a wireless mouse with magnetic resonance effect, in which the wireless mouse supplier includes a shoot area and a computer side magnetic resonance device. The shoot area is a part of a covering case of the notebook computer; the computer side magnetic resonance device is set within the notebook computer and disposed under the shoot area, in which the computer side magnetic resonance device includes a computer side rectification circuit that rectifies a supply power and generates an induced magnitude field for supplying the wireless mouse.

### RELATED APPLICATIONS

This application claims priority to Chinese Application Serial Number 201120008130.1, filed Jan. 7, 2011, which is herein incorporated by reference.

### BACKGROUND

1. Field of Invention

The present invention relates to a supply device. More particularly, the present invention relates to the supply device for supplying the mouse.

2. Description of Related Art

Generally speaking, the current computer mice can be broadly classified into two types, the mechanical computer mice and the optical computer mice. The mechanical type computer mouse usually includes a trackball, and the code-axis or the grating device converts the trace of the trackball to digital signal which is transferred to the computer through the transmission line, such that the mouse cursor on the computer screen moves accordingly.

The optical type mouse emits the light source which irradiates the mouse pad or desk through a small hole on the bottom of the computer mouse; when the light is reflected to the light sensor inside the computer mouse, the varying image of the mouse pad or the desk is captured. The computer mouse's movement obtained through comparing and calculating is then transferred to the computer through the transmission line for further computing and operation.

Both of the mechanical type mouse and the optical type mouse are tied with a transmission line which is necessary for passing the operation data or movement data of those computer mice from the computer mice to the computer, and the transmission line needs to move with the computer mouse when the computer mouse is moved. However, the transmission line might be stumbled when the computer mouse moves, which blocks the moving of the computer mouse.

In order to solve the problem, the information industry tries to develop a different kind of computer mouse which is more convenient for use. The industry has gradually developed the wireless mouse which doesn't need to employ the transmission line. The transmitter module, which transmits the movement and the click of the wireless mouse to the computer, is installed inside the wireless mouse. For example, the movement and the click of the wireless mouse are passed to the computer by wireless communication system is such as the Bluetooth.

However, the wireless mouse either requires batteries to provide power, or requires additional external charge equipment to charge/supply the wireless mouse, which is neither economic nor convenient. Therefore, there is a need for a new wireless mouse which requires no external charge/supply device.

### SUMMARY

According to one embodiment of the present invention, the wireless mouse supplier, disposed within a notebook computer, supplies a wireless mouse with magnetic resonance effect, in which the wireless mouse supplier includes a shoot area and a computer side magnetic resonance device. The shoot is a part of a covering case of the notebook computer, and the computer side magnetic resonance device is set within the notebook computer and disposed under the shoot area, in which the computer side magnetic resonance device includes a computer side rectification circuit for rectifying a supply power and generating an induced magnitude field for supplying the wireless mouse.

According to another embodiment of the present invention, the wireless mouse supply system, supplying a wireless mouse with magnetic resonance effect, includes a wireless mouse and a mouse side rectification circuit. The wireless mouse includes a covering surface, a receive area, and mouse side magnetic resonance device. The receive area is a part of the covering surface and receives induced magnetic field. The mouse side magnetic resonance device is disposed inside the wireless mouse and faces the receive area, in which the mouse side magnetic resonance device includes a mouse side rectification circuit influenced by an induced magnetic field, and the mouse side rectification circuit accordingly resonates and generates an induced current.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A shows one portion diagram of the wireless mouse supply system according to one embodiment of the present invention;

FIG. 1B shows another portion diagram of the wireless mouse supply system according to another embodiment of the present invention;

FIG. 1C shows the other portion diagram of the wireless mouse supply system according to another embodiment of the present invention;

FIG. 2 shows the block diagram of the computer side magnetic resonance device according to another embodiment of the present invention;

FIG. 3 shows the block diagram of the mouse side magnetic resonance device according to another embodiment of the present invention; and

FIG. 4A shows the circuit diagram of the computer side rectification circuit according to one embodiment of the present invention; and

FIG. 4B shows the circuit diagram of the mouse side rectification circuit according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The wireless mouse supplier and the wireless mouse supply system of the following embodiments can supply the wireless mouse by the magnetic resonance effect without the external charging device/batteries, which eliminates the cost and the battery replacing procedures and is economic, space saving, as well as environmental.

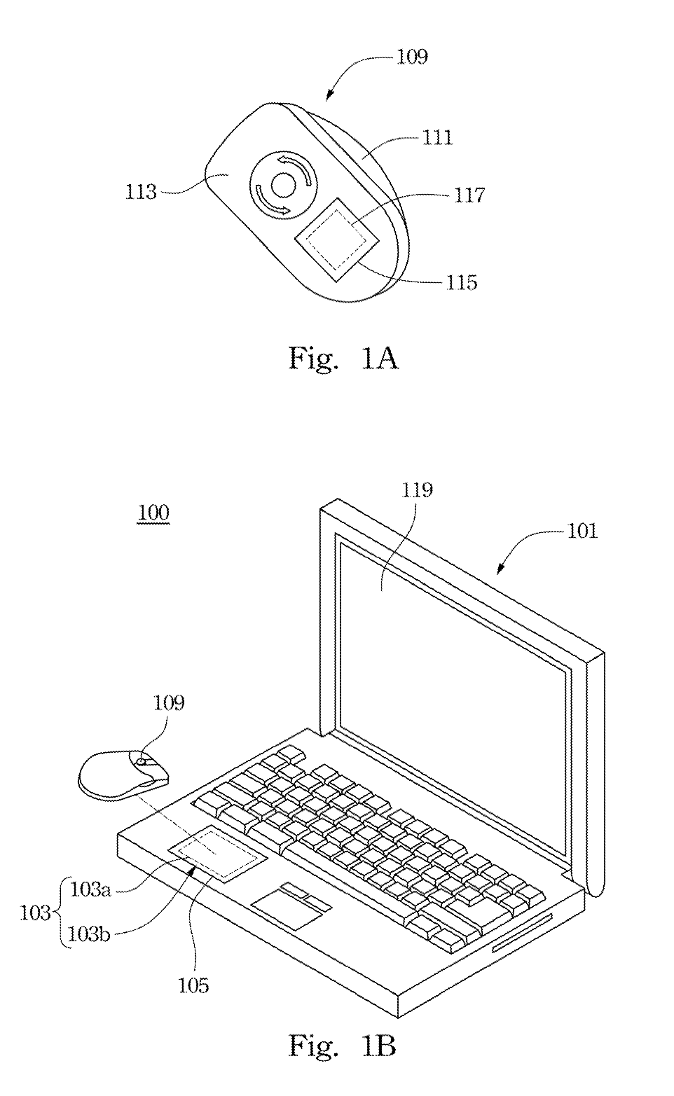

Please simultaneously refer to FIG. 1A, FIG. 1B, and FIG. 1C which show different portion diagrams of the wireless mouse supply system according to the embodiments of the present invention. The wireless mouse supply system 100 supplies the wireless mouse 109 by the magnetic resonance effect, in which the wireless mouse supply system 100 includes the wireless mouse 109 and the wireless mouse supplier 103.

The wireless mouse 109 can process the data with the optical technique. For example, the wireless mouse 109 can encode the optical signal which contains the input data and transmit the encoded signal through the radio wave; the notebook computer 101 then receives and decodes the encoded signal carried by the radio wave, transforms the decoded signal into specific type required by the notebook computer 101, and the notebook computer 101 can further process the data in that specific type.

The wireless mouse 109 includes the covering surface 111 and the mouse side magnetic resonance device 117 disposed under the covering surface 111. The receive area 115 is a part of the covering surface 111, and the mouse side magnetic resonance device 117, disposed within the wireless mouse 109 and facing the receive area 115, converts the received induced magnetic field for supplying the wireless mouse 109. In more detail, the receive area 115 is disposed on the bottom 113 of the covering surface 111; the wireless mouse supplier 103 can supply the wireless mouse 109 once the receive area 115 on the bottom 113 faces the shoot area 103b of the wireless mouse supplier 103, and the battery or the external supply device is no longer required, which facilitates the usage of the wireless mouse 109.

On another aspect, the wireless mouse supplier 103 is disposed within the notebook computer 101 and supplies the wireless mouse 109 with the magnetic resonance effect, in which the wireless mouse supplier 103 includes the shoot area 103b and the computer side magnetic resonance device 103a. The shoot area 103b is a part of the covering case of the notebook computer 101 and has a closed boundary 105 within which the wireless mouse 109 can be disposed to be supplied; that is, when the receive area 115 of the wireless mouse 109 faces the shoot area 103b, the wireless mouse 109 is charged effectively even if it doesn't contact with the shoot area 103b.

The computer side magnetic resonance device 103a of the wireless mouse supplier 103, disposed within the notebook computer 101 and under the shoot area, generates an induced magnetic field to supply the wireless 109.

As shown in FIG. 1B, the shoot area 103b is a part of the keyboard area of the notebook computer 101, and the wireless mouse 109 is attached to the shoot area 103b located near the keyboard through the magnet or other attach element; the shoot area 103b can also be a part of the covering case 121 as shown in FIG. 1C, while the wireless mouse 109 is attached to the shoot area 103b on the covering case 121 through the velcro or other attach element.

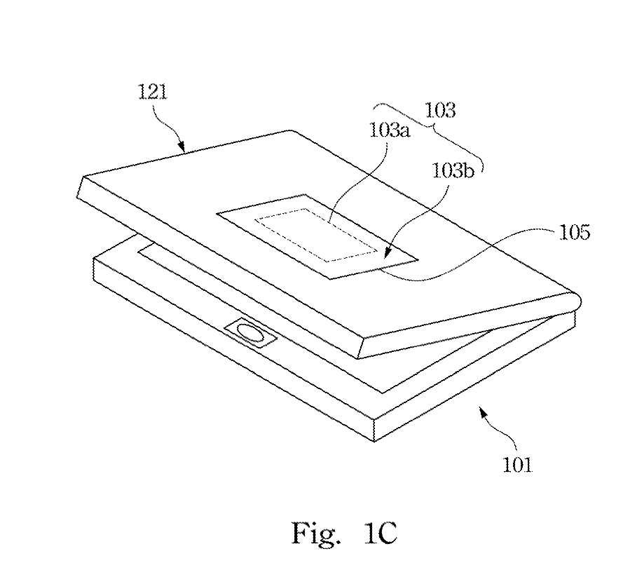

FIG. 2 shows the block diagram of the computer side magnetic resonance device according to another embodiment of the present invention. The computer side magnetic resonance device, set within the notebook computer and disposed under the shoot area, includes an alternating current source 201, a direct current source 203, a switch device 211, a power control module 205, a computer side rectification circuit 207, and a radio frequency power transmission circuit 209.

The switch circuit 211 switches the alternating current source 201 and a direct current source 203, and the switch circuit 211 passes one of the current source to the power control module 205. The power control module 205 converts the alternating current source 201 or the direct current source 203 into the supply power.

The computer side rectification circuit 207 rectifies the supply power and accordingly generates the induced magnitude field for supplying the wireless mouse. The computer side rectification circuit 207 includes an inductor coil which receives and converts the supply power provided by the power control module 205 into the induced magnetic field, and the computer side rectification circuit 207 also emits the induced magnetic field for supplying the wireless mouse.

The computer side magnetic resonance device further includes a radio frequency power transmission circuit 209 electrically connected to the power control module 205 for receiving the supply power, in which the radio frequency power transmission circuit 209 emits the radio frequency electromagnetic wave to supply the wireless mouse.

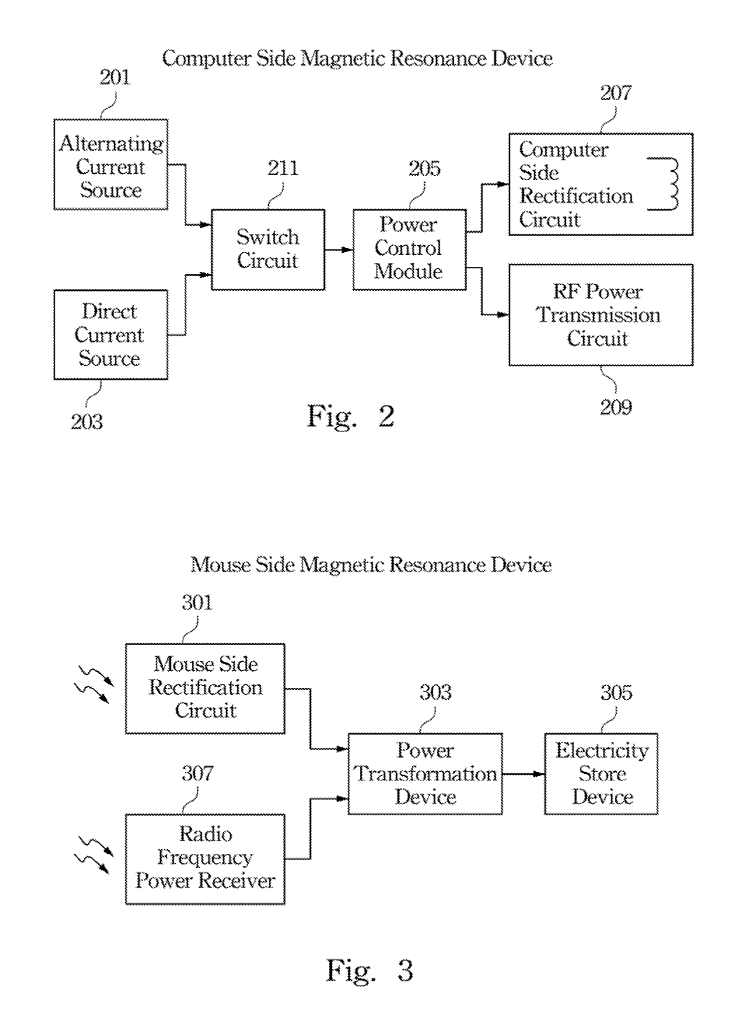

FIG. 3 shows the block diagram of the mouse side magnetic resonance device according to another embodiment of the present invention. The mouse side magnetic resonance device is disposed inside the covering surface of the wireless mouse and faces the receive area, in which the mouse side magnetic resonance device includes a mouse side rectification circuit 301, a radio frequency power receiver 307, a power transformation device 303, and a electricity store device 305.

The mouse side rectification circuit 301 is influenced by the induced magnetic field, generated by the computer side rectification circuit (shown in FIG. 2), and resonates to generate the induced current accordingly, in which the mouse side rectification circuit 301 includes an inductor coil, such as the spiral copper coil. When the inductor coil of the mouse side rectification circuit 301 is in the induced magnetic field and resonates, the induced current is generated to supply the wireless mouse. In other words, one of the inductor coil is employed to be the source (in the computer), and the other inductor coil is employed to be the load (in the wireless mouse); and the two inductor coils resonate with the same resonate frequency. In this embodiment, the resonance is the magnetic resonance, and power greater than 60 W can be produced by using magnitude coupled resonance coil. Power of such level can be wirelessly transmitted beyond 2 meters, which improves the power transition efficiency. Furthermore, the length/height of the inductor coil can be adjusted slightly to induce the inductor coils strongly resonate and supply the wireless mouse effectively. The object disposed between the inductor coil pair does not affect the magnetic field.

The power transformation device 303 converts the induced current or the radio frequency electromagnetic wave received by the radio frequency power receiver to a supply power, such as the direct supply current, for supplying the wireless mouse. The radio frequency power receiver 307 also converts the electromagnetic wave from the radio frequency power transmission circuit (sign 209 in FIG. 2) into the supply power for supplying the wireless mouse. The electricity store device 305 receives and stores the direct supply current coming from the power transformation device 303 for backup.

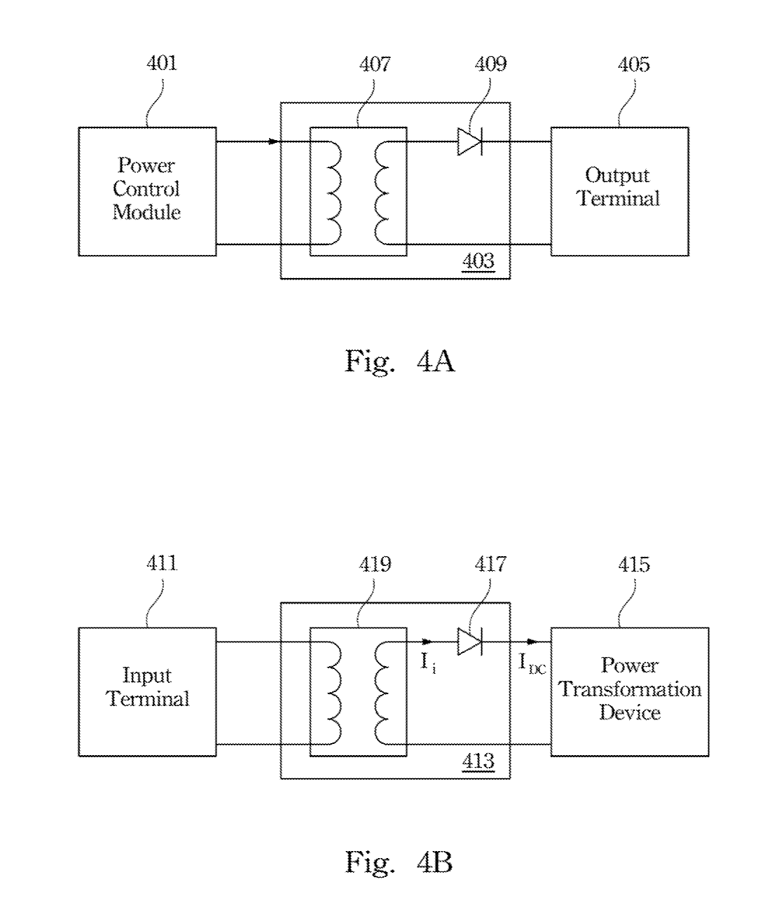

FIG. 4A shows the circuit diagram of the computer side rectification circuit according to one embodiment of the present invention. In FIG. 4A, the power control module 401 converts an alternating current source or a direct current source into the supply power and provides the supply power to the computer side rectification circuit 403. The computer side rectification circuit 403 includes the inductor coil 407 and the diode 409. The inductor coil 407 generates the induced magnetic field after it has received the supply power, such as the alternating current; the output terminal 405 outputs the induced magnetic field.

FIG. 4B shows the circuit diagram of the mouse side rectification circuit according to one embodiment of the present invention. In FIG. 4B, the input terminal 411 receives the induced magnetic field; the mouse side rectification circuit 413, electrically connected between the input terminal 411 and the power transformation device 415, includes the inductor coil 419 and the diode 417. When the inductor coil 419 is disposed in the induced magnetic field, the induced current Iᵢ rectified by the diode 417 to be the direct current I_{DC}, is generated by the resonance effect. Then, the direct current I_{DC} is provided to the power transformation device 415, and the power transformation device 415 generates the supply power which supplies the wireless mouse according to the direct current I_{Dc}.

The wireless mouse supply device and the wireless mouse supply system of the above embodiments can supply the wireless mouse in the absence of the external charge/supply device or batteries, which saves the space, eliminates the cost and the battery replacing procedures, and is both convenient as well as environmental; the power of the wireless mouse will not be broken off just because the user doesn't replace the battery on time, and the backup batteries are no longer required. In addition, the wireless mouse can move freely without being stumbled by the transmission line, which facilitates the using of the wireless mouse.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless mouse supplier, disposed within a notebook computer, supplies a wireless mouse with magnetic resonance effect, wherein the wireless mouse supplier comprises:
a shoot area being a part of a covering case of the notebook computer; and
a computer side magnetic resonance device set within the notebook computer and disposed under the shoot area, in which the computer side magnetic resonance device comprises:
a computer side rectification circuit for rectifying a supply power and generating an induced magnitude field for supplying the wireless mouse.

2. The wireless mouse supplier as claimed in claim 1, wherein the computer side rectification circuit comprises an inductor coil for converting the supply power into the induced magnetic field emitted to supply the wireless mouse.

3. The wireless mouse supplier as claimed in claim 2, wherein the computer side magnetic resonance device further comprises a power control module which converts an alternating current source or a direct current source into the supply power for supplying the inductor coil.

4. The wireless mouse supplier as claimed in claim 3, wherein the computer side magnetic resonance device further comprises a radio frequency power transmission circuit electrically connected to the power control module, wherein the radio frequency power transmission circuit emits the electromagnetic wave to supply the wireless mouse.

5. The wireless mouse supplier as claimed in claim 1, wherein the shoot area is a part of a keyboard area of the notebook computer, and the wireless mouse is attached to the shoot area for being supplied.

6. The wireless mouse supplier as claimed in claim 1, wherein the shoot area has a closed boundary within which the wireless mouse is disposed to be supplied.

7. A wireless mouse supply system, supplying a wireless mouse with magnetic resonance effect, the wireless mouse supply system comprising:
a wireless mouse, comprising:
a covering surface;
a receive area, being a part of the covering surface, for receiving induced magnetic field; and
a mouse side magnetic resonance device disposed inside the wireless mouse and facing the receive area, wherein the mouse side magnetic resonance device comprises:
a mouse side rectification circuit, influenced by the induced magnetic field, accordingly resonating and generating an induced current.

8. The wireless mouse supply system as claimed in claim 7, wherein the mouse side rectification circuit comprises an inductor coil, influenced by the induced magnetic field, accordingly resonated and generating the induced current.

9. The wireless mouse supply system as claimed in claim 7, wherein the wireless mouse further comprises:
a radio frequency power receiver for receiving an electromagnetic wave; and
a power transformation device for converting the induced current or the electromagnetic wave received by the radio frequency power receiver to a supply power for supplying the wireless mouse.

10. The wireless mouse supply system as claimed in claim 7, further comprising a wireless mouse supplier disposed within a notebook computer, wherein the wireless mouse supplier comprises:
a shoot area being a part of a covering case of the notebook computer; and
a computer side magnetic resonance device set within the notebook computer and disposed under the shoot area, in which the computer side magnetic resonance device comprises:
a computer side rectification circuit generating the induced magnitude field for supplying the wireless mouse.
